(19) United States
(12) Patent Application Publication
(10) Pub. No.: US 2008/0131628 A1
(43) Pub. Date: Jun. 5, 2008

(54) Glass Substrate For Viewing Display

(75) Inventors: Sylvie Abensour, Montlignon (FR); Pedro-Pablo Mazon Ramos, Aviles (Asturias) (ES); Nathalie El Khiati, Deuil La Barre (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SAINT-GOBAIN GLASS FRANCE, Courbevoie (FR)

(21) Appl. No.: 11/576,578

(22) PCT Filed: Sep. 30, 2005
(86) PCT No.: PCT/FR2005/050801

§ 371 Date: Dec. 27, 2007

(30) Foreign Application Priority Data
Oct. 4, 2004 (FR) 0452254

(51) Int. Cl. E06B 3/00; C03C 3/087; C03C 3/095; C03C 3/04

(52) U.S. Cl. 428/34; 501/53; 501/70; 501/64; 501/71

(57) ABSTRACT

The invention relates to the field of displays. One subject of the invention is a glass composition intended for the production of a substrate for a field-emission display, which has an overall light transmission factor under illuminant D₆₅ (TL_{D65}) that varies from 45 to 80% and is preferably equal to 72% or less, measured for a glass thickness of 2.8 mm, and a blue-gray coloration defined by the following chromatic coordinates:

a*=−4 to +1, preferably −2 to 0; and

b*=−6 to +3, preferably −2 to 0.

The substrates obtained advantageously have a reflection brightness (R) of less than 10 Cd/m².

The invention relates to the field of display panels and more particularly to a glass substrate intended to form the front face of field-emission display panels.

Although not limited to such applications, the invention will be more particularly described with regard to substrates used for displaying an image using a display panel of the field-emission type, such as a plasma display panel.

A plasma display panel is generally made up of two glass plates, more commonly called “substrates”, that are separated by a space in which a mixture of plasma gases (Ne, Xe, Ar) is trapped. The internal face of the rear substrate is provided with phosphors that are excited by the ultraviolet radiation emitted by the plasma gas mixture undergoing plasma discharge between the two substrates and generate visible light radiation (red, green, blue). The image produced from this radiation is projected through the front substrate.

The emission of light is accompanied also by infrared radiation at between 800 and 1250 nm which passes through the front substrate of the display panel. This radiation is likely to disturb the operation of neighboring equipment controlled by infrared, for example by means of remote controls.

When the gas mixture contains neon, radiation in the intense orange at 590 nm is generated at the same time as the infrared radiation. This orange radiation as such is disagreeable to the viewer's eye and also interferes with the colors blue and green, which are perceived as being washed-out, and with the color red, which seems less sharp.

Moreover, like all electrical equipment, plasma displays have addressing systems (called “drivers”) that generate electromagnetic waves liable to interfere with devices such as microcomputers mobile telephones, etc.

To limit the drawbacks associated with the propagation of the aforementioned undesirable radiation, it is usual to apply, against the front substrate of the display, a structure that is both transparent and metallized, in order to provide electromagnetic shielding, and acts as an optical filter, cutting off the orange color and ensuring good color rendition.

Such a structure is described for example in WO-A-2004/016053. This is an assembly of two plastic sheets covering an electromagnetic shielding element (metal wires or thin metal films) and comprising at least one mineral pigment or an organic dye acting as orange filter. The assembly may either be held in place at a certain distance from the display by peripheral fastening means, or it may be applied directly to the glass of the front substrate by means of an adhesive.

In general, the front substrate is made of toughened glass so as to have better impact strength, and its external face, which in the final arrangement faces the viewer, is coated with an advantageously antireflection coating.

However, it has been found that certain properties of the display are not entirely satisfactory. In particular, when the display is in a strongly illuminated environment, a substantial proportion of the incident light is reflected off the front face of the display, which makes the image blurred in diffuse transmission. There is therefore a need to improve both the contrast and the brightness of the image

Solutions for remedying these drawbacks are already known.

In WO-A-99/26269, the front substrate consists of a soda-lime silicate glass containing neodymium oxide Nd₂O₃ and possibly nickel oxide NiO and/or cobalt oxide CoO, in order to fine-tune the chromaticity and the transmittance.

In U.S. Pat. No. 5,888,917 the front substrate has a spectral transmission of at least 87% within the wavelength range from 400 to 700 nm with a thickness of 1.5 to 3.5 mm. According to one embodiment, the glass contains less than 0.02% FeO and at least one of the following oxides: cobalt oxide (0-150 ppm), nickel oxide (0-1200 ppm).

It appears however that the performance of the display does not allow an image of high quality to be obtained under intense illumination conditions.

Moreover, it has been found that the image obtained from display panels comprising the structure described previously in WO-A-2004/016053, in which an adhesive is used, does not have a constant quality and quality tends to degrade over time. The reduction in image quality seems to result from aging of the adhesive under the effect of the temperature rise of the display under operating conditions. This aging modifies the light transmission and/or the color.

The object of the invention is to propose glass compositions for producing substrates permitting an image to be displayed with a high contrast and high luminance, the quality of which does not degrade over time, and which substrates can undergo the usual treatments aimed at limiting electromagnetic radiation in the infrared and in the orange.

The object of the invention is also to provide glass compositions that allow the production of substrates by the float process, in which molten glass is floated on a bath of molten metal, under conditions similar to those for a conventional soda-lime silicate glass.

These objects are achieved according to the invention by a glass composition of the soda-lime silicate type intended for the manufacture of substrates for field-emission display panels, the said composition having an overall light transmission factor under illuminant D₆₅ (TL_{D65}) that varies from 45 to 80%, and is preferably equal to 72% or less, measured for a glass thickness of 2.8 mm, and a blue-gray coloration defined by the following chromaticity coordinates:

a*=−4 to +1, preferably −2 to 0; and

b*=−6 to +3, preferably −2 to 0.

Preferably, the glass compositions according to the invention have a light reflection coefficient or reflection brightness (R) equal to or less than 10 Cd/m² and advantageously less than 8 Cd/m².

Preferably, the glass composition according to the invention possesses a strain point above 530° C., and advantageously above 570° C.

Also preferably, the glass composition has a thermal expansion coefficient α₂₀₋₃₀₀ of between 75 and 95×10⁻⁷ K⁻¹, preferably less than 84×10⁻⁷ K⁻¹.

More precisely, the glass compositions according to the invention are characterized in that they contain constituents suitable for forming the glass matrix and coloring agents.

The glass matrix of the compositions according to the invention comprises the constituents below, in the following proportions by weight:

| | |
|---|---|
| SiO₂ | 53-75% |
| Al₂O₃ | 0-10% |
| ZrO₂ | 0-8% |
| Na₂O | 2-8% |
| K₂O | 0-10% |
| Li₂O | 0-2% |
| CaO | 0-12% |
| MgO | 0-9% |
| SrO | 0-12% |
| BaO | 0-12%. |

Preferably, the glass matrix comprises:

| | |
|---|---|
| SiO₂ | 57-75%, preferably greater than 68% |
| Al₂O₃ | 0-7%, preferably 1-6% |
| ZrO₂ | 2-7%, preferably 2.5-4.5% |
| Na₂O | 2-6%, preferably 3-5% |
| K₂O | 2-10%, preferably 5-9% |
| Li₂O | 0-1%, preferably less than 0.5% |
| CaO | 2-11%, preferably 5-11% |
| MgO | 0-4%, preferably 0-2% |
| SrO | 2-9%, preferably 5-9% |
| BaO | 0-9%, preferably 0-5%. |

According to a first embodiment, the glass composition includes, as coloring agents, the combination of CoO and NiO in the following proportions, expressed in percentages by weight:

| | |
|---|---|
| CoO | 10-150 ppm, preferably 30-100 ppm |
| NiO | 30-800 ppm, preferably 100-600 ppm |
| NiO/CoO | less than 5. |

This composition makes it possible to obtain a glass that possesses a particularly advantageous neutral coloration with a slightly blue tint and has a light transmission factor and reflection brightness that are relatively moderate. The compositions containing both at least 50 ppm CoO and 200 ppm NiO make it possible in particular to obtain a light transmission factor of less than 72% and a reflection brightness equal to or less than 8 Cd/m².

The glass composition defined above may further contain other coloring agents, thereby making it possible to fine-tune the color of the glass and the light transmission (TL_{D65}). As an example, mention may be made of chromium oxide Cr₂O₃, manganese oxide MnO₂, neodymium oxide Nd₂O₃, vanadium oxide V₂O₅, iron oxides (Fe₂O₃ and FeO) and/or erbium oxide Er₂O₃, and selenium Se. The total content of these coloring agents does not exceed 3%, preferably 1%.

Preferably, the NiO/CoO weight ratio is equal to 4 or less and is advantageously greater than 2.

In a second embodiment, the glass compositions contain as coloring agents the combination of CoO and Cr₂O₃ in the following proportions expressed in percentages by weight:

| | |
|---|---|
| CoO | 20-150 ppm, preferably 30-100 ppm |
| Cr₂O₃ | 30-400 ppm, preferably 40-300 ppm. |

The glass composition according to this embodiment may further contain other coloring agents so as to adjust the color of the glass and the light transmission (TL_{D65}). As an example, mention may be made of nickel oxide NiO, manganese oxide MnO₂, neodymium oxide Nd₂O₃ vanadium oxide V₂O₅, iron oxides (Fe₂O₃ and FeO) and/or erbium oxide (Er₂O₃), and selenium Se. The total content of these coloring agents does not exceed 3%, preferably 1%.

According to a third embodiment, the glass compositions contain as coloring agents, the combination of Nd₂O₃ and Cr₂O₃ in the following proportions by weight:

| | |
|---|---|
| Nd₂O₃ | 0.5-3%, preferably 0.5-2% |
| Cr₂O₃ | 40-500 ppm, preferably 50-400 ppm. |

The glass composition defined above may further contain other coloring agents, allowing the color of the glass and the light transmission (TL_{D65}) to be fine-tuned. Examples that may be mentioned include: nickel oxide NiO, cobalt oxide CoO, manganese oxide MnO₂, vanadium oxide V₂O₅, iron oxides (Fe₂O₃ and FeO) and/or erbium oxide Er₂O₃, and selenium Se. The total content of these coloring agents does not exceed 1%, preferably 0.5%.

The glass compositions according to the invention have in particular the advantage of being able to be melted and converted into glass ribbon under the standard conditions of the float process, at temperatures similar to those used in the manufacture of conventional soda-lime silicate glass.

In these compositions, SiO₂ plays an essential role. Within the context of the invention, the content must not exceed 75%; above this, melting of the batch requires a high temperature, and moreover the thermal expansion coefficient of the glass becomes too low. Below 53%, the stability and the strain point of the glass are insufficient.

Al₂O₃ plays a stabilizing role. It allows the strain point of the glass to be increased, and it improves the chemical resistance, especially in a basic medium. The percentage of Al₂O₃ advantageously does not exceed 10%, preferably 7%, and better still 6%, in order to prevent an unacceptably large increase in the viscosity at high temperatures and to prevent an excessive reduction in the thermal expansion coefficient.

ZrO₂ also acts as a stabilizer. It improves the chemical resistance of the glass and helps to increase the strain point. Above 8%, the risk of devitrification increases and the thermal expansion coefficient decreases. Even though this oxide is difficult to melt, it is advantageous as it does not increase the viscosity of the glass at high temperatures to the same extent as SiO₂ and Al₂O₃.

In general, the melting of the glass compositions according to the invention remains within acceptable limits provided that the sum of the oxides SiO₂, Al₂O₃ and ZrO₂ also remains at or below 75%. The term “acceptable limits” is understood to mean that the temperature of the glass corresponding to a viscosity η of 100 poise does not exceed 1550° C. and preferably 1510° C.

Na₂O and K₂O keep the melting point and the viscosity at high temperatures within the limits given above. They also control the thermal expansion coefficient. The total content of Na₂O and K₂O is generally at least equal to 8% preferably at least equal to 10%. Above 15%, the strain point becomes too low. As a general rule, the K₂O/Na₂O weight ratio is at least equal to 1, preferably at least equal to 1.2.

It is also possible to incorporate Li₂O into the glass composition as a flux, in a content that may be up to 2%, but preferably does not exceed 1% and advantageously 0.5%. As a general rule, the composition does not contain Li₂O.

The alkaline-earth meta oxides CaO, MgO, SrO and BaO have the effect of reducing the melting point and the viscosity of the glass at high temperatures. They also generally raise the strain point. The total content of these oxides is generally at least equal to 15%. Above 25%, the risk of devitrification becomes incompatible with the float process conditions.

The BaO content, generally less than 12%, is preferably less than 9% and better still less than 5% in order to limit the formation of barium sulfate (BaSO₄) crystals that impair the optical quality of the glass. Preferably, the BaO content in the glass corresponds to the inevitable impurities of the batch materials.

SrO helps to raise the strain point and increases the chemical resistance of the glass. Its content is preferably less than 9%.

The glass composition according to the invention can be melted and converted into glass ribbon by floating the glass on a bath of molten metal under the conditions of the float process for conventional soda-lime silicate glass compositions.

The glass ribbon is then cut to the appropriate dimensions in order to form substrates for display panels, especially as the front face.

The examples that follow illustrate the invention without however limiting it.

Glass compositions comprising a glass matrix and the coloring agents given in Table 1 were produced.

The glass matrix of Examples 1 to 13 and 15 contained the following constituents, in percentages by weight

| | |
|---|---|
| SiO₂ | 68.5% |
| Al₂O₃ | 0.7% |
| Na₂O | 4.5% |
| K₂O | 5.5% |
| CaO | 10.0% |
| SrO | 7.0% |
| ZrO₂ | 3.8%. |

Each composition was placed in a platinum crucible and melted at 1500° C. The molten glass was deposited on a carbon table and formed into a sheet. The sheet was annealed in a furnace at 655° C. for 60 minutes. The sheet was cut into specimens measuring 50×50×2.8 mm, which were then polished. The following parameters were measured on the specimens:
the overall light transmission factor under illuminant D₆₅ (TL_{D65}) and the chromatic coordinates a* and b* integrated between 380 and 780 nm. The calculations were made using the C.I.E (1931) calorimetric reference observer; and
the reflection brightness (R) in Cd/m². A portable spectrophotometer (MINOLTA CM-2600d) was placed on the glass specimen deposited on an opaque support, on the free face in contact with the glass. The spectrophotometer was equipped with a light source and a detector that measured the reflected light

Examples 11 to 13 and 15 are comparative examples of a glass composition comprising the abovementioned glass matrix but not containing the combination of coloring agents according to the invention.

Comparative Example 14 correspond to a glass substrate for a field-emission display, the glass matrix of which contained the following constituents, in percentages by weight:

| | |
|---|---|
| SiO₂ | 58.00% |
| Al₂O₃ | 6.75% |
| Na₂O | 4.10% |
| K₂O | 6.40% |
| CaO | 4.95% |
| MgO | 2.00% |
| SrO | 7.05% |
| BaO | 8.00% |
| ZrO₂ | 2.95%. |

The compositions according to the invention make it possible to obtain glass sheets whose strain point and thermal expansion coefficient are compatible with their use as display panel substrates, which provide better image contrast and better image brightness than the known substrate (Example 14).

The glass compositions containing both CoO and NiO (Examples 4 to 9) have better properties in terms of TL_{D65} and coefficient R than the compositions not containing CoO and NiO (Example 11) or containing only one of them (Examples 12 and 13).

Likewise the compositions that contain both Nd₂O₃ and Cr₂O₃ (Example 10) have better properties than those that contain only Nd₂O₃ (Example 15).

| | Example | | | | | | | | | | | | | | |
|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 |
| Color- | | | | | | | | | | | | | | | |
| ing | | | | | | | | | | | | | | | |
| agents | | | | | | | | | | | | | | | |
| CoO | 60 | 50 | 55 | 50 | 50 | 40 | 50 | 55 | 55 | 15 | — | 50 | — | — | — |
| (ppm) | | | | | | | | | | | | | | | |
| NiO | — | — | — | 200 | 200 | 100 | 200 | 220 | 220 | 160 | — | — | 200 | — | — |
| (ppm) | | | | | | | | | | | | | | | |
| Cr₂O₃ | 170 | 100 | 150 | — | 30 | — | — | — | 50 | 120 | — | — | — | — | — |
| (ppm) | | | | | | | | | | | | | | | |
| MnO₂ | — | — | — | — | — | 150 | — | 200 | — | — | — | — | — | — | — |
| (ppm) | | | | | | | | | | | | | | | |
| Se | — | 40 | — | — | — | — | 5 | — | — | — | — | — | — | — | — |
| (ppm) | | | | | | | | | | | | | | | |
| Er₂O₃ | — | — | 2000 | — | — | — | — | — | — | — | — | — | — | — | — |
| (ppm) | | | | | | | | | | | | | | | |
| Nd₂O₃ | — | — | — | — | — | — | — | — | — | 1 | — | — | — | — | 1 |
| (%) | | | | | | | | | | | | | | | |
| Fe₂O₃ | 0.07 | 0.10 | 0.07 | 0.07 | 0.07 | 0.07 | 0.07 | 0.07 | 0.07 | 0.07 | 0.07 | 0.07 | 0.07 | 0.11 | — |
| (total | | | | | | | | | | | | | | | |
| iron) | | | | | | | | | | | | | | | |
| (%) | | | | | | | | | | | | | | | |
| FeO | 0.02 | 0.03 | 0.02 | 0.02 | 0.02 | 0.02 | 0.02 | 0.02 | 0.02 | 0.02 | 0.02 | 0.02 | 0.02 | 0.04 | — |
| (%) | | | | | | | | | | | | | | | |
| Prop- | | | | | | | | | | | | | | | |
| erties | | | | | | | | | | | | | | | |
| TL_{D65} | 76.2 | 79.7 | 77.8 | 70.0 | 70.7 | 79.0 | 70.0 | 71.7 | 69.0 | 70.0 | 89.7 | 82.5 | 83.8 | 89.8 | 80.5 |
| (%) | | | | | | | | | | | | | | | |
| a* | −3.1 | −2.3 | −2.1 | −1.3 | −1.5 | −0.6 | −0.7 | −0.7 | −1.2 | −2.0 | −0.6 | −0.9 | −0.6 | −1.0 | −0.2 |
| b* | −3.9 | −3.1 | −3.4 | −1.7 | −1.6 | −2.0 | −1.5 | −1.8 | −1.0 | −1.6 | +0.2 | −4.4 | +3.3 | +0.17 | −6.1 |
| R | 9.1 | 9.9 | 9.5 | 7.7 | 7.8 | 9.7 | 7.7 | 8.0 | 7.4 | 7.6 | 12.2 | 10.6 | 10.9 | 12.4 | 10.1 |
| (Cd/m²) | | | | | | | | | | | | | | | |
| Strain | 580 | 580 | 580 | 580 | 580 | 580 | 580 | — | — | — | 580 | 580 | 580 | 570 | — |
| point | | | | | | | | | | | | | | | |
| (° C.) | | | | | | | | | | | | | | | |
| α₂₀₋₃₀₀ | 78 | 78 | 78 | 78 | 78 | 78 | 78 | — | — | — | 78 | 78 | 78 | 83 | — |
| (10⁻⁷ | | | | | | | | | | | | | | | |
| K⁻¹) | | | | | | | | | | | | | | | |

1. A glass composition of the soda-lime silicate type intended for the manufacture of substrates for displays, especially field-emission display panels, characterized in that this composition has a light transmission factor under illuminant D₆₅ (TL_{D65}) that varies from 45 to 80%, and is preferably equal to 72% or less, measured for a glass thickness of 2.8 mm, and a blue-gray coloration defined by the following chromatic coordinates:
a*=−4 to +1, preferably −2 to 0; and
b*=−6 to +3, preferably −2 to 0.

2. The composition as claimed in claim 1, characterized in that it has a reflection brightness (R) of less than 10 Cd/m², preferably less than 8 Cd/m².

3. The composition as claimed in either of claims 1 and 2, characterized in that it possesses a strain point above 530° C., and advantageously above 570° C.

4. The composition as claimed in one of claims 1 to 3, characterized in that the thermal expansion coefficient α₂₀₋₃₀₀ is between 75 and 95×10⁻⁷ K⁻¹, preferably less than 84×10⁻⁷ K⁻¹.

5. The composition as claimed in one of claims 1 to 4, characterized in that it comprises constituents suitable for forming the glass matrix and coloring agents, said constituents being present in the following proportions by weight:

| | |
|---|---|
| SiO₂ | 53-75% |
| Al₂O₃ | 0-10% |
| ZrO₂ | 0-8% |
| Na₂O | 2-8% |
| K₂O | 0-10% |
| Li₂O | 0-2% |
| CaO | 0-12% |
| MgO | 0-9% |
| SrO | 0-12% |
| BaO | 0-12%. |

6. The composition as claimed in claim 5, characterized in that it includes, as coloring agents, the combination of CoO and NiO in the following proportions, expressed in percentages by weight:

| | |
|---|---|
| CoO | 10-150 ppm, preferably 30-100 ppm |
| NiO | 30-800 ppm, preferably 100-600 ppm |
| NiO/CoO | less than 5. |

7. The composition as claimed in claim 6, characterized in that the NiO/CoO ratio is less than 4, preferably greater than 2.

8. The composition as claimed in claim 5, characterized in that it contains as coloring agents the combination of CoO and Cr₂O₃ in the following proportions, expressed in percentages by weight:

| | |
|---|---|
| CoO | 20-150 ppm, preferably 30-100 ppm |
| Cr₂O₃ | 30-400 ppm, preferably 40-300 ppm. |

9. The composition as claimed in claim 5 characterized in that it contains as coloring agents, the combination of Nd₂O₃ and Cr₂O₃ in the following proportions expressed in percentages by weight:

| | |
|---|---|
| Nd₂O₃ | 0.5-3%, preferably 0.5-2% |
| Cr₂O₃ | 40-500 ppm, preferably 50-400 ppm. |

10. The use of the glass composition as claimed in one of claims 1 to 9 for the production of a substrate for a display, in particular a field-emission display, especially from a glass sheet cut from a glass ribbon obtained by floating the glass on a bath of molten metal.

11. The use as claimed in claim 10, characterized in that the substrate forms the front face of a plasma display.

12. A display panel, in particular a field-emission display panel, comprising two glass substrates separated by a space containing a mixture of plasma gases, characterized in that at least one of the substrates consists of a glass of a composition as claimed in one of claims 1 to 9.

13. The display panel as claimed in claim 12, characterized in that the substrate forms the front face.
